(19) United States
(12) Patent Application Publication
(10) Pub. No.: US 2010/0030597 A1
(43) Pub. Date: Feb. 4, 2010

(54) Internet Content Delivery Management System

(76) Inventors: Michael W. Lewis, JR., Poway, CA (US); Roland J. Lewis, III, Ewing, NJ (US); Peter Yang, Rowland Heights, CA (US)

Correspondence Address: LAW OFFICE OF MARK WISNOSKY, 3200 Fourth Avenue, Suite 201, SAN DIEGO, CA, 92103, US

(21) Appl. No.: 12/183,271

(22) Filed: Jul. 31, 2008

(51) Int. Cl. G06Q 30/00; G06Q 10/00

(52) U.S. Cl. 705/7; 705/14.49

(57) ABSTRACT

A delivery management engine that monitors and controls system Internet content delivery, primarily advertisement, is presented. The system uses automated scripts to track delivery of content and includes a discrepancy reconciliation engine that reconciles delivery counts between multiple server systems. The system includes user encoded business rules that enable automatic adjustments to advertisement campaigns to ensure that a contracted number of deliveries is met. The system avoids both over-delivery and under-delivery of content against a target and therefore optimizes the use of valuable advertising space.

### BACKGROUND OF THE INVENTION

1. Technical Field

The present invention relates to a monitoring and control system for Internet advertising.

2. Related Background Art

Worldwide growth of the use of the Internet has resulted in it becoming the medium of choice for advertising. Commercial enterprises based primarily on Internet advertising rank amongst the largest revenue companies of the world. The growth in Internet advertising has resulted in heretofore unknown business models and methods unique to an electronic medium. Individual web sites can become revenue generating sites just by virtue of their popularity for presentation of advertising. The owner of a web site can contract with multiple advertisers to present their advertisements on his site in and be paid for this presentation on a per view, per click or other basis. Often the advertisement includes complex graphics, interaction capability and sound and video. The content may also change with time or with the nature of the site on which it is presented. Most often the content for electronic advertisement is not stored in the same location as the content for the site. Web sites are essentially computer programs written in a variety of languages such as hypertext markup language (HTML), extensible markup languages (XML) and a host of variations. Each of these languages makes use of the hypertext transfer protocol (HTTP) of the Internet to transfer content between computing systems. Unique file names and tags identify content. A web site consists of a program for formatting and presenting content that may be accessed from multiple servers worldwide. The content can and often is physically stored on servers located practically anywhere in the world that is connected to the World Wide Web. The owner of a web site will often contract with multiple advertisers whose content is stored on multiple different servers.

Many web site owners' sites are too small to warrant individual attention from an advertiser. A web site owner may work through a broker to sell advertising space on his site. A broker will represent multiple web sites that individually do not represent sufficient traffic to warrant the attention of an advertiser, but collectively the web sites do represent a commercially important volume of traffic. In some cases the access to content through a broker requires an additional step of accessing the broker's server for the pointer to the location of the file containing the advertisement content and then accessing the content itself. Home PC's must make at least two web requests before rich media ads are delivered. Each time the target PC must redirect its call to another ad server in order to obtain the ad content, another hop is required. A web site may contract with multiple brokers and ultimately accessing tens or even hundreds of content files. A web site owner usually contracts for a fixed number of views of the advertisement on his site. Once that number is reached then the web site owner either switches the displayed advertisement to another advertiser or is no further advertisements are contracted displays local “filler” advertisements often for no revenue. If a web site continues to access and display an advertisement beyond the contracted number there is no additional revenue that accompanies this free advertisement. If the web site displays less than the contracted number of views then revenue is reduced. Since web publishers believe, prematurely, they have satisfied the terms of a campaign, their servers will cease delivering higher value ad impressions in favor of lower value house ads. While a discrepant impression can never be recaptured, delivering less revenue efficient impressions should be avoided. Accurate counting of the number of views of each advertisement is critical.

Since delivering ad content is based on embedded server tags delivered along side web content, ads are delivered asynchronously and may not be delivered at all if a user's connection is broken for any reason during this process. Differences between the counts for the number of times an advertisement content is accessed are “discrepancies”. Reconciliation of these discrepancies is important to provide accurate accounting and payment for viewing of web site content. Hop counts, and the discrepancies that accompany them, have increased with the sophistication of the online advertising business model. Often discrepancies arise because of the nature of an individual's interaction with the Internet. If, for example, an individual clicks on a URL or icon that may initiate access to an advertisement content but then closes the page before content is viewed, the local site may count a viewing that the broker system or a content provider system does not because transfer of content did not actually take place. If a site is accessed by a web crawler or other automated system a viewing may be counted for access to the site that was not a human initiated viewing. Multiple disperse systems may be accounting for the number of times an advertisement is accessed: the local web site, the broker and the content provider. Online delivery metrics between ad servers differ on average from 3% to 7%. Discrepancies among ad/content servers are such a recognized problem that leading industry groups such as the Internet Advertising Bureau (IAB.net) have addressed and included methods on how to account for and bill for discrepant campaigns within their standardized Terms and Conditions for online advertising.

Because of the distributed nature of the content and the multiple paths by which content may be accessed accounting for the number of views of an advertisement on a web site is difficult. Compiling and comparing the reports from the various systems is currently done manually. Frequently accounting for the number of views of an advertisement is done through manually accessing the local web site, the content provider server, and the brokers' server. In an attempt to stay ahead of under-deliveries, publishers employ traffickers to monitor and adjust their campaigns in an attempt to deliver more revenue-effectively. This can be costly since there is currently no standard application program interface (API) for ad-serving and all reports must be manually reconciled. Accounting may be available in data bases associated with the various sites, may be accessed through integrated counters in the web site programming code or other means. Reports are obtained by accessing particular web sites or reported electronically via e-mail or other means. Accurate accounting requires hours of manpower on a monthly basis. The current system is open to human error and is costly.

The web site owners attempt to use the collected data to avoid over delivery or under delivery of each particular advertisement content. But, even after hours of data collection, it can be unclear what modifications should be made to existing campaigns to maximize ongoing deliveries. Labor requirements for data gathering make daily adjustments to campaigns impossible. Therefore changes are made on a time scale permitted by the available manpower to monitor a site and content delivery rates. This results in adjustments in the advertisement campaign that are made after the campaign is significantly over or under delivered. Large corrections are required. The current tactic of manually adjusting campaign schedules produces a “step-effect”. This effect becomes more and more dilutive to campaign management efforts as the period between adjustments grows large. Changes to the advertisement campaign are often not simply a matter of adjusting for over or under delivery. The adjustments should optimally take into account the contracted reward for advertisement delivery and manage the campaign to maximize revenue to the web site owner. Adjustments need to be made on a time scale that iteratively reaches a contracted goal for content delivery rather than making gross step-changes in delivery tactics that result in over-delivery or under-delivery of advertisement content. There is a need for a system that can automatically and accurately account for web site advertisement viewing across multiple systems and from multiple sources. There is a need for a system that can reconcile differences in the accounting from these multiple sources. There is a need for a system that can automatically adjust a web site display policy for optimum revenue generation from displayed advertisement. There is a need for a system that can adjust the web site display policy for contractual variations.

### DISCLOSURE OF THE INVENTION

An automated delivery management engine that access multiple sites, checks for data specific to particular web site advertisements and provides a reconciled accounting of access to web site advertisement content is disclosed. The engine largely eliminates manual human access to multiple sites to gather data and accounting. Delivery data discrepancies amongst multiple sites' reports are reconciled to provide an accurate account of the number of views of particular web advertisement content. In the discussion that follows the terms “system” and “engine” are used interchangeably. The invention may reside on a single server as a piece of software or it may reside more generally on multiple locations dispersed across a network. In either case the disclosed embodiments are representative of the invention. The automated system can be run at frequent intervals, daily or even more frequently. The system can automatically adjust the advertisement display policies of a site as the number of reconciled actual viewings of advertisement content exceeds or lags a contractually agreed to number of viewings or viewing rate. The system may access data through multiple means and compile a centralized report.

A customer of the system signs up and encodes the contracted advertisements for his web site. The encoding includes account information as well as creative script tags and other unique identifiers of accessed web content. Account information is accessed through direct login to content provider accounts, access to electronically mailed reports from content providers and brokers and access to data base information available on content provider and other sites. Multiple content providers and multiple broker information may be encoded to capture a complete view of the contracted advertisement on the site. In another embodiment encoding includes a set of rules for prioritizing delivery of content.

Account information is retrieved according to the encoded information retrieval plan. Local web site delivery data is matched with third party delivery data retrieved from broker or advertisement content sites. Matching is done through automated searching for creative script tags that uniquely identify advertisement content. A single report is available that indicates discrepancies between counted deliveries of content by third party broker or advertisement content providers sites and counts of the delivered content by the local site. The discrepancy may indicate an over-delivery of content or an under-delivery of content.

In another embodiment, the encoding also includes a plan for response to automatically adjust advertisement priority based upon weighting or other parameters to increase or decrease the likelihood of an advertisement being selected. Should one advertisement exceed a contracted viewing, an optimum substitute advertisement is selected from others available. If a high value advertisement is lagging in the number of views it may move up in priority to make up the deficit against a contracted number of views.

In the following discussion the viewing of web content in the form of advertisement is used for exemplary purposes to illustrate the invention. Application to other web content accounting problems would be apparent to those skilled in the art and are intended to be included within the scope of the invention.

### BRIEF DESCRIPTION OF THE DRAWINGS

FIG. 1 is a block diagram of a network on which embodiments of the invention may be practiced.

FIG. 2 is a block diagram of a computing system on which embodiments of the invention may be practiced.

FIG. 3 is a block diagram of data flow for content.

FIG. 4 is a block diagram showing communication paths amongst participants in content distribution and display.

FIG. 5 is a flow chart for an initialization embodiment of the invention.

FIG. 6 is a flow chart for a data acquisition embodiment of the invention.

FIG. 7 is a flow chart for a data analysis, reporting and correction embodiment of the invention.

FIG. 8 is a web page image and web page instruction code for a data acquisition embodiment of the invention.

FIG. 9 shows graphs related to a correction embodiment of the invention.

### DETAILED DESCRIPTION

A system for managing the contracted delivery of content from multiple remote systems across the Internet is described. The system is comprised of an account creation embodiment, a data acquisition embodiment, a data reporting and analysis embodiment and an automated campaign adjustment embodiment. In this description advertisement content is used for exemplary purposes, and the term advertisement, or ads and content are used interchangeable. Advertisement is increasingly becoming rich media content and delivery of such content across the Internet is becoming a standard for delivery. Rich media content is often advertisement and may include videos, music or any other form of electronically encoded content that is delivered across the Internet. Management of the contracted delivery of content that is not advertisement may also benefit from embodiments of the invention. An advertising campaign is a planned delivery of content to visitors of a web page. The campaign may include content from multiple advertisement content providers contracted directly or through brokers.

In the account creation embodiment the customer of the invented system would encode a unique set of identifiers to enable the automated data acquisition from multiple remote servers for advertisement or other content that the web site owner has contracted for display on his site. The encoding generates an automation script for the repetitive tasks of collecting content delivery data. The encoding includes login names, passwords, servers, email addresses, URL addresses for remote servers and other credentials and information required to access content delivery data.

The data acquisition embodiment uses a set of scripts encoded in the account creation step to access the data related to content delivery to a particular web site. Non-limiting examples of scripts include requesting database reports, accessing electronically mailed reports, and logging onto particular web sites where delivery data is available. The scripts include searching content and site code for tags that uniquely identify content. The data acquisition embodiment compiles a centralized report for the advertisement campaign of a web site.

The analysis and reporting embodiment of the invention collects the data from diverse sources and organizes the data such that delivery of content related to a campaign can be viewed in a single report. In a further embodiment the analysis includes reconciling differences or discrepancies between content delivery data from multiple sources. Over-delivery and under-delivery of particular advertisement content is reported.

The campaign adjustment embodiment uses a business rule encoded at account setup to optimize the delivery of advertisement content through the web site. The site adjusts the campaign for over-delivery and under-delivery of content according to the encoded business rules and relative priority assigned to contracted content. The result is an automated advertisement campaign content delivery management system for contracting web sites.

Advertising content is frequently delivered through a chain of agents. For example a web site owner may contract with a broker who distributes content for several advertiser / content deliverers. Rules for delivery of content including the number of advertisement content files to deliver and relative priority of which files to deliver may be managed at multiple locations in the chain of the web site, the broker(s) and the content provider(s). In another embodiment the delivery parameters throughout this chain are managed.

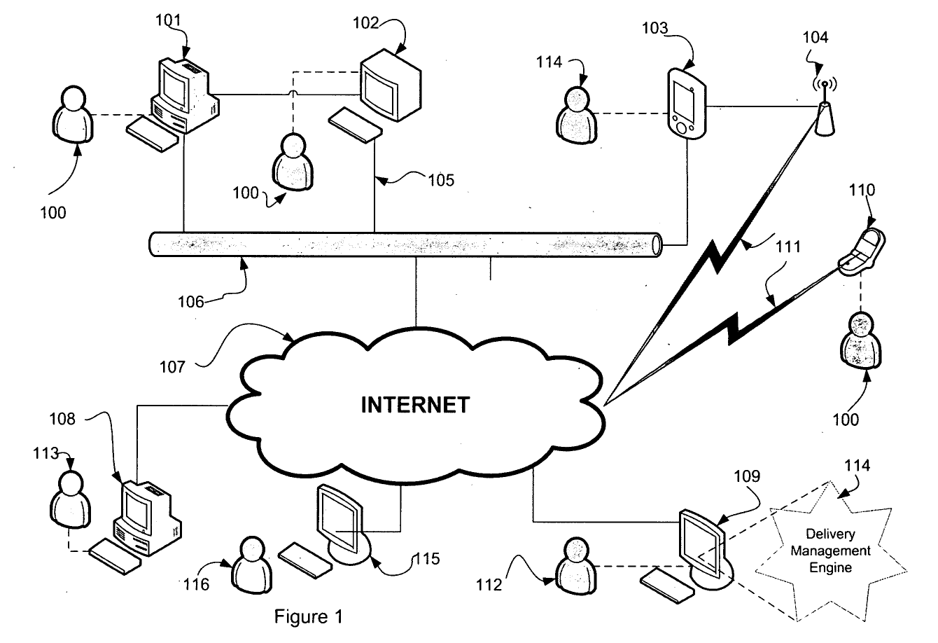

FIG. 1 shows a computer network in which embodiments of the invention may be practiced. Users 100 may access the Internet through computers 101, terminals 102, Personal data assistants 103 or cellular telephones 110 and any other Internet protocol (IP) enabled device. Exemplary users include, but are not limited to: advertising networks, advertising exchanges, representation firms or brokers, Internet auction clearing houses, and/or direct publisher advertising servers (web sites), individual web site owners and any advertisement content provider. These are the types of commercial users this system will most directly benefit.

Access may be through local area networks 106 which then are linked to the Internet through wired 105 or through wireless means 104, 111. The system also consists of servers 108 operated by or for the benefit of web site owners 113 which make web sites and various content available to the users 100 who access the content typically through web browser programs running on any of a variety of computing devices. Content displayed on a web site may be available from the local server 108 or from remote servers 115. Remote servers may be operated by for example advertisers 116 who offer advertisement content for viewing on a web site and pay web site owners for such display.

Embodiments of the current invention 114 are made operational by people practicing the invention 112 on servers 109 also connected to the Internet. The servers may be separate from those supporting users web sites 108 and those providing content 115, as shown, but also may be on the same servers as those used by web site owners and content providers.

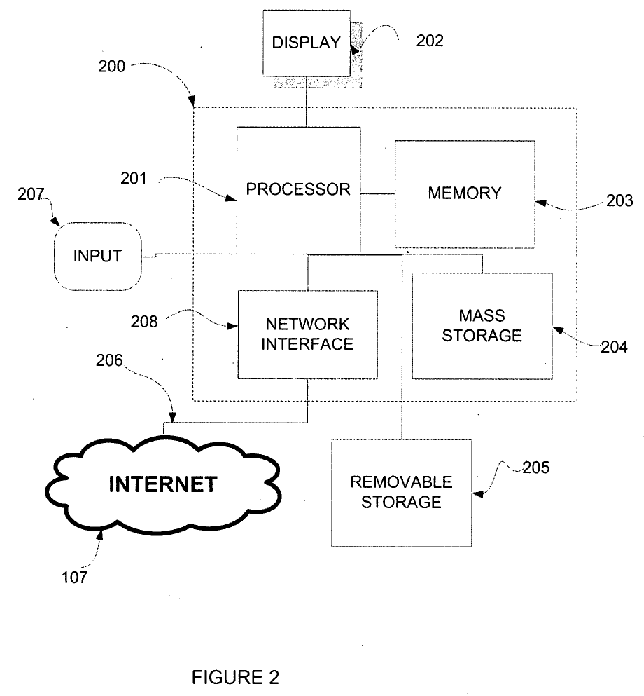

FIG. 2 shows more detail of a personal computing device 200 on which embodiments of the invention may be practiced. The system includes input means 207, typically a keyboard and mouse or other pointing device connected to a processor that has access to both local memory 203 such as RAM and ROM, which may provide either volatile or nonvolatile storage. Typical systems will include a mass storage device 204 that is usually a hard disc drive and a means 205 to read and write from and to removable storage media such as magnetic or optical. Smaller devices such as cell phones, PDA's and other IP enabled devices often will include only solid-state memory components. Feedback to the user is provided by a display means 202 such as a liquid crystal display. Embodiments of the invention may be written and accessed when stored in memory directly integrated to the processor 201 or other memory locations 203, 204 and 205. The system further includes a network interface 208 that is connected 206 to the Internet 107. Connection means 206 may be wired or wireless. In another embodiment the invention may be practiced on any computing device that may be connected to the Internet. Non-limiting examples of such devices include networked games, personal data assistants and cell phones. Personal computers and other devices such as PDA's and cell phones on which the invention may be practiced are referred to hereinafter as personal computing devices.

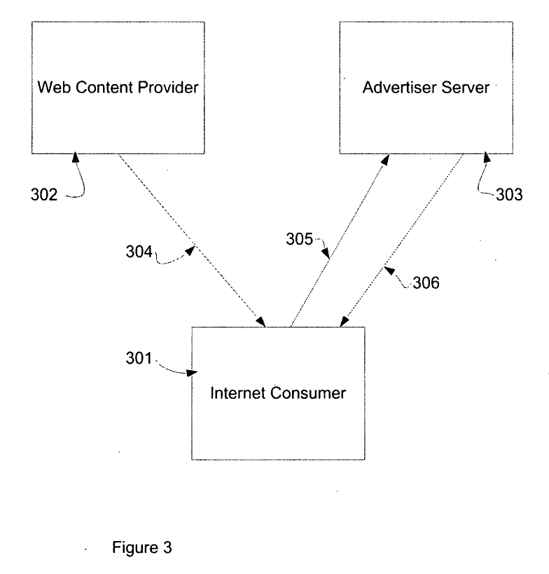

FIG. 3 depicts a block diagram of typical data requests and content flow in the form of electronic data. The Internet consumer 301 is typically using a personal computing device and a browser program to access web content from a web content provider 302. Data is transmitted to the Internet consumer 304 and displayed on his local computing device. The web content consists of a browser program file including instructions for displaying content in the form of a web page and may further include data files of images, sounds, movies or other media for display as part of the accessed web page. The content from the web content provider may also include commands to be sent 305 to an advertiser server 303 to initiate download of content 306 to the Internet consumer system for viewing. Note that coding for which content to provide is contained at the web content provider but the advertiser server provides the actual content. Such deliveries of information are common for the Internet and advertising campaigns. The web content provider typically has a contract with the advertiser for deliveries of content as accessed through their site as shown. A user click, an impression on a delivered page or an action taken by a page viewer, may define deliveries. Contracts are typically paid for as a cost per click, cost per impression or cost per action. Accounting for the number of deliveries is important for payment by the advertiser to the web content provider. The web content provider may count the number of times data is requested and web content is downloaded 304. The advertiser may count the number of viewings as the number of actual downloads from the advertiser server 306. These numbers may not agree thus generating discrepancies in the accounting. The Internet consumer 301 may switch to another site, disable browser the browser, be using the browser in a non-graphics mode, be disconnected from the internet, have download of content fail due to network bandwidth issues or even simple power failures. There are a host of reasons that content requested is not delivered from the advertiser server 306. The count of the number of requests for content 304, 305 may not match the number of actual deliveries 306. Embodiments of the instant invention enable reconciliation of the requests 304, 305 and the actual downloads 306. This reconciliation embodiment takes place through a discrepancy reconciliation engine which may run in conjunction or as a part of the content delivery management engine.

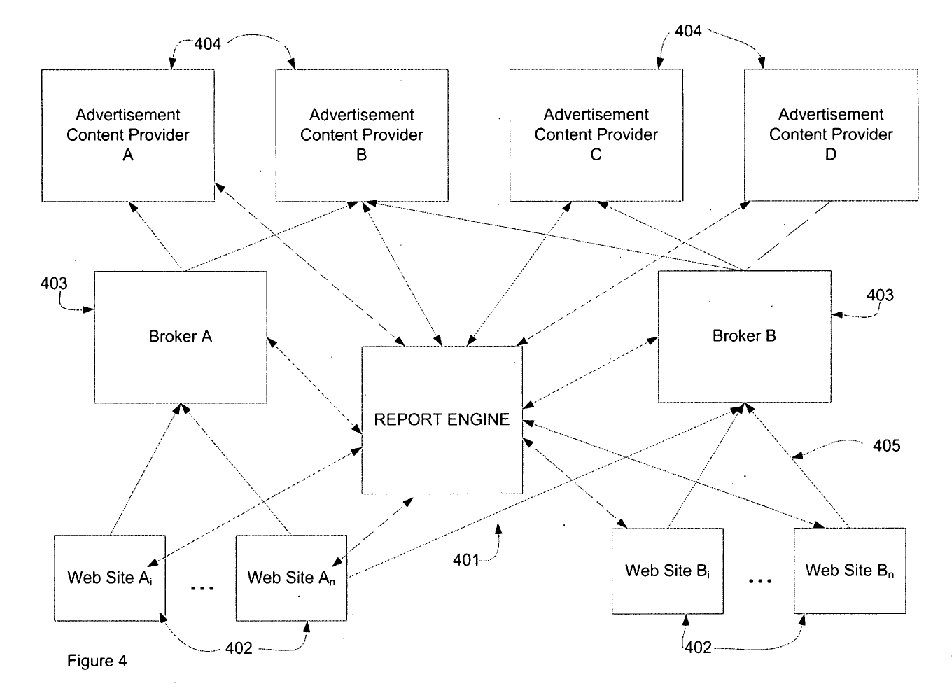

A block diagram for the network interactions in a report engine embodiment of the invention is shown in FIG. 4. The various blocks of FIG. 4 can represent both the network hardware related to advertising campaigns and the parties participating in such campaigns. The interconnecting arrows represent exemplary contractual interactions as well as data transfers between hardware components. The interconnecting arrows shown are for exemplary purposes only. There may in an actual system be more or fewer interaction pathways. Non-limiting examples of data include a command line requesting transfer of content as well as the transfer of the content itself. Data transfer between the report engine and the web site 402, broker 403 and advertisement servers 404 may also include request for information regarding number of downloads of content and the reply report of download statistics. The report engine 401 provides a centralized collection point for information, analysis and control amongst the parties involved in a web based advertising campaign. The web sites 402 typically contract with advertiser 404 through a broker 403. As shown multiple web sites may contract with a particular broker. A web site may contract with multiple brokers. The broker combines the requirements of multiple web sites 402 to present a larger deal to an advertiser 404. Advertisers may deliver content through a single broker or through multiple brokers. A contract is negotiated for display of advertising content from the advertisement server onto individual consumer web views as shown and discussed in FIG. 3. An individual web site may have contracts for delivery of advertisement content for multiple advertisers 404. Such content is to be accessed by the individual consumer from multiple advertisement servers. Each individual web site 402 may be accessed by literally millions of Internet consumers, each accessing content along paths similar to those discussed in FIG. 3. The delivery management engine 401 works with individual web sites 402, brokers 403 and content providers 404 through processes and programs described in following paragraphs. The delivery management engine queries web sites 402, brokers 403 and content providers 404, for content delivery data. The delivery management engine reconciles data received from the web site 402 with the data received from the brokers 403 and the advertisement content providers 404. In another embodiment the report engine consolidates data from multiple advertisement servers to provide a consolidate report to each web site 402. In another embodiment the report engine sends modified campaign parameters to the web site 402 to optimize revenue for contracted display of content from advertisers 404. In another embodiment rules for content delivery on the web site, the brokers' site and the content providers' site are all automatically modified according to a pre-selected plan. Each system that selects from multiple content delivery choices runs programs termed ad servers. The ad servers are proprietary programs that automatically decide which content to deliver and or display. Typically ad server programs attempt to optimize delivery based upon factors such as profitability, impression counts, click counts, eCPM, specific page locations or other metrics of a site or broker account based upon contractual relationships for content delivery. Ad servers are running on the web site 402 that contracts for multiple sources of advertisement content, the broker site 403 that may choose amongst multiple content providers' content to be delivered to multiple web sites and on the advertisement content provider site 404 to decide which content should be delivered. Ad servers include a weighting parameter that allow the person setting up several campaigns to be able to tell the server which campaigns are preferred over others on a variety of objective and subjective measures.

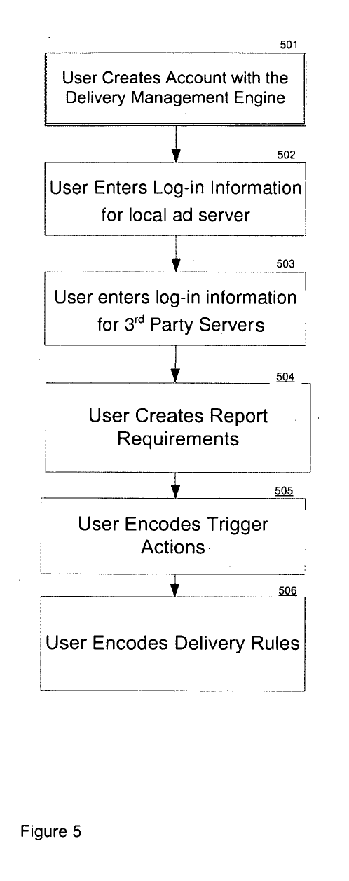

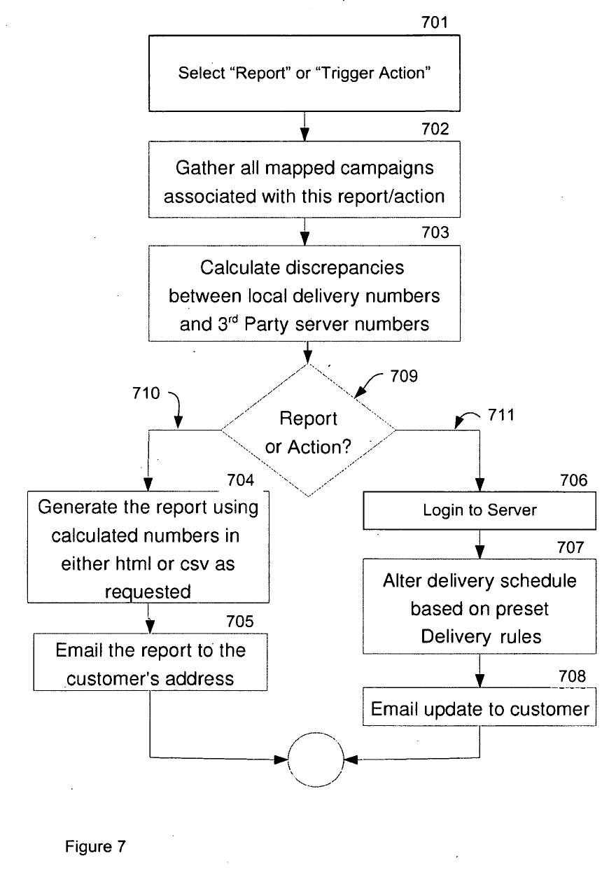

A flow chart for a user account creation embodiment of the invention is shown in FIG. 5. Since the delivery management engine works by simulating the repetitive tasks of digital content advertising account managers, accounts are created to contain pertinent user information of a web site including user names, passwords and email addresses (501) as well as login information for the various ad servers where the web site pulls their delivery data. The user adds a local ad server account, including address, login and password where the delivery management engine can go to both look up current campaign delivery information and where adjustments can be made to delivery parameters such as scheduled impressions and scheduled clicks (502). In a preferred embodiment this is an http interface that is deployed using the HTML web language. This ad server account is therefore accessed over the user's web browser. The user further provides information on where to retrieve 3rd party ad server delivery information 503. Non-limiting exemplary connections include another http/HTML web interface address along with login and password information, mail accounts where 3rd party reports are delivered electronically using any electronic mail protocol such as POP3, IMAP or other electronic means of communication such as SMS and XML, and a direct URL that directs the delivery management engine to the location of the most current report data on the web (503). The user further creates a series of reports and trigger actions 504 which are to be applied to the campaigns contained within the servers listed in 502 and 503. A report takes delivery data, which was reported in the 3rd party ad server report and matches it to the equivalent deliveries in the local ad server and report potential under and over deliveries to the user as discussed below. In one embodiment the user may then decide, based on delivery management engine recommendation, to perform a particular adjustment to their campaign 504.The user encodes trigger actions that configure basic business rules within the system, which, similarly to 504, will match up equivalent campaign deliveries. The delivery management engine will modify the delivery parameters of the campaign in question on the local server to adjust for under or over delivery discrepancy automatically without any further user intervention. The delivery management engine works through the ad servers using predetermined business rules that are discussed in more detail in conjunction with FIG. 7.

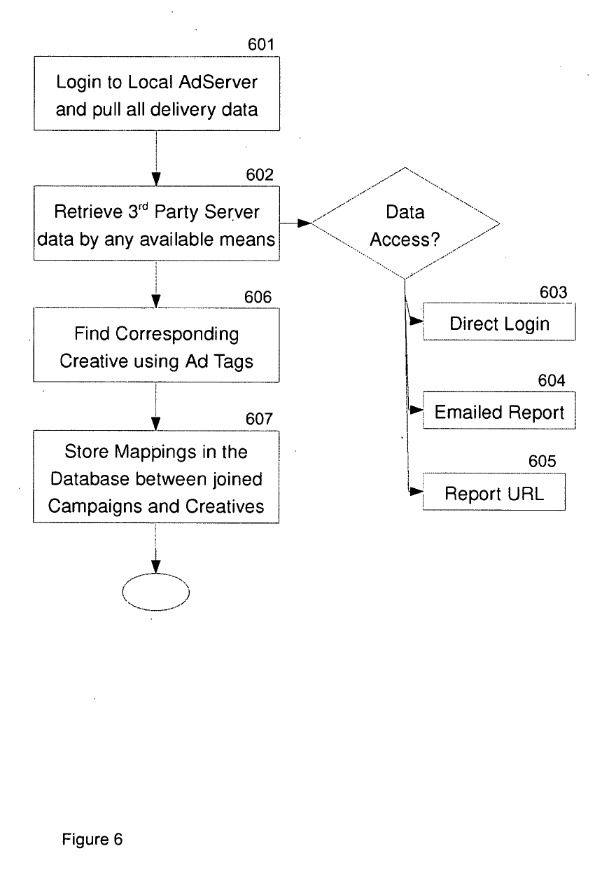

FIG. 6 shows a flow diagram for a data acquisition embodiment of the invention. The current level of ad server accounting industry-wide is to report numbers on a daily basis. In a preferred embodiment the delivery management engine performs a daily gathering of the previous days reports based on the delivery time of the each 3rd party server's report 602. The delivery management engine also logs into the local server, after nightly accounting has been performed, and fetch the current delivery data for all local campaigns 601. The report delivery method for receiving data from 3rd party servers includes, but not limited to, web access via direct login to the customers account (603), electronic mail protocol to a delivery address (604) and a direct URL location (605). After new campaigns are sorted and saved in the database, the delivery management engine will look for matching campaigns based on the relationship between the unique identifiers of 3rd party campaigns and the data which can be mined from the script code embedded in the local server's database for delivery of the local ad. This data is typically, but not limited to, JavaScript or HTML code (606). Mappings are then filed in the delivery management engine database for later use during report and action processing. Changes to these fundamental mappings are also presented to the user when they occur since mapping changes could be a sign of data corruption or inadvertent campaign alteration. In another embodiment the data acquisition is done at intervals prompted by the user. In yet another embodiment the data acquisition is done automatically at intervals defined in the previously discussed user interface embodiment.

FIG. 7 depicts data analysis, reporting and campaign adjustment embodiments of the invention. After data collection has been performed, reports and trigger actions are analyzed to check if report delivery is to be run or if any local ad server alterations are needed (701). For each report or action, all of the campaigns that have been assigned to this report or action are called up from the database as well as any mappings that have been identified to exist between these active campaigns 702. Campaigns assigned to a report or action are defined in the previously discussed user setup embodiment. Using the data that has been gathered in the previous steps, discrepancies between mapped campaigns are calculated and updated in the database 703. Separate paths are followed for either a report or an action. If this is a report 704, the discrepancy and delivery information is formatted into for example the HTML or CSV (coma separated values, spreadsheet) file that was selected by the user when the report was created in user setup embodiment of FIG. 5. The report may be emailed 705 to the address that was stored with the user account when the account was created or updated last. If this is a trigger action the system automatically logs 706 into a server using the login credentials that were provided by the user when the action was created 705. The server which is logged into may be a local web site server, a broker server or an advertisement content provider server. In another embodiment multiple types of servers are logged into and reports are obtained or campaign management rules are modified. The discrepancy information calculated in step 703 will be run thru the business rules 707 that were applied when the user created the trigger. These business rules will determine the type and amount of alteration that should be made to the campaign on the local ad server. Changing the relative priority of a campaign may be done through a change in the weighting for a campaign or by a change in any other parameters to increase or decrease the likelihood of a campaign being selected. Weighting, one means to change the relative priority, is a parameter for a proprietary algorithm, which is employed by each ad server on the market in a slightly different and proprietary way. They are meant to allow the person setting up several campaigns to be able to tell the server which campaigns are preferred over others on purely subjective measures (since it could simply use the amount of money per impression for a subjective measure). Business rules that delivery management engine would employ would be of the variety including, but not limited to:

1. Changing the number of impressions or clicks scheduled in order to compensate for the lost discrepant ones or for slowing down a campaign that is over delivering.

2. Changing the relative priority of a campaign when it falls discrepant. An increase inversely proportional to the time remaining to deliver it will increase the odds of a very discrepant campaign with only a short time to live delivering in full on time. A decrease will slow down a campaign that is over delivering and thereby make room for a campaign that is under delivering.

3. Changing the allowable daily overage. This tells the ad server, if there is a limit to how many impressions can be done in a single day, increase that by X % to attempt to squeeze out some additional daily impressions. An increase will boost the chance that an under delivering campaign returns to target a decrease will slow down a campaign that is over delivering.

All of these methods can be used by themselves or in any combination to create a single business rule for discrepancy reconciliation. Exemplary business rules also include, but are not limited to, increasing scheduled delivery, decreasing scheduled delivery, increasing campaign delivery weight, decreasing delivery weight and stopping the delivery of the campaign. In a preferred embodiment, any modification made via the business rule will be sent to the user with a description of what change was made and under what business rule it was authorized 708. In another embodiment the delivery management engine triggers actions that effect ad servers on multiple points: the web site, the broker site and the advertisement content provider site. Thus effectively controlling multiple steps in the chain of content delivery.

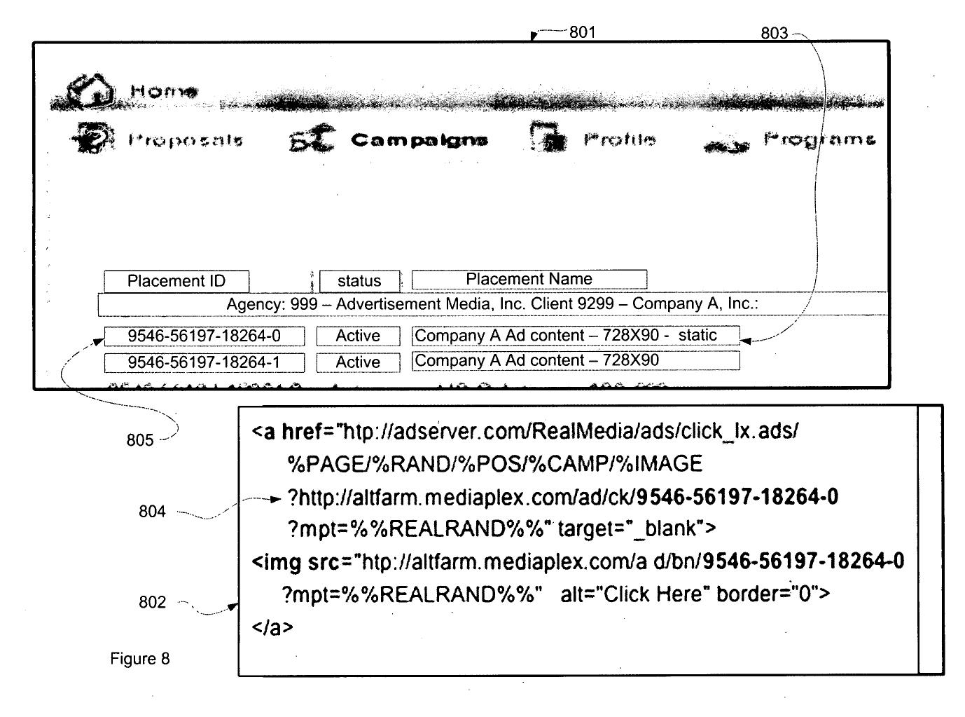

FIG. 8 depicts an automatic matching embodiment of the invention. There are 2 pages being depicted, 801, 802. These are a remote websites' representation of the advertisement campaigns being delivered. Advertisement campaigns are identified both by name 803 and by a unique identifier or tag 804. The source code tags are held on the local ad server, these are used to tell the end-PC-user's browser where to go to fetch the remote advertisement. In one embodiment the delivery management engine matches the identifier tags 805 and identifiers 803 of reports tags embedded in code 804 to provide automatic reporting on number of times a particular content was delivered locally and compare that count with the delivery report from the remote advertisement content provider and broker sites. The setup embodiment of the invention includes descriptions of advertisement campaigns 801 that include specific creative script tags 805 that uniquely identify calls for content delivery. An embodiment of the invention searches coded instructions for web sites 802 for lines that contain references to the creative script tag 804 and to commands that initiate download of content related to the creative script tag 805. Each instance of a download command line is counted a delivery of the identified content to the local web site server.

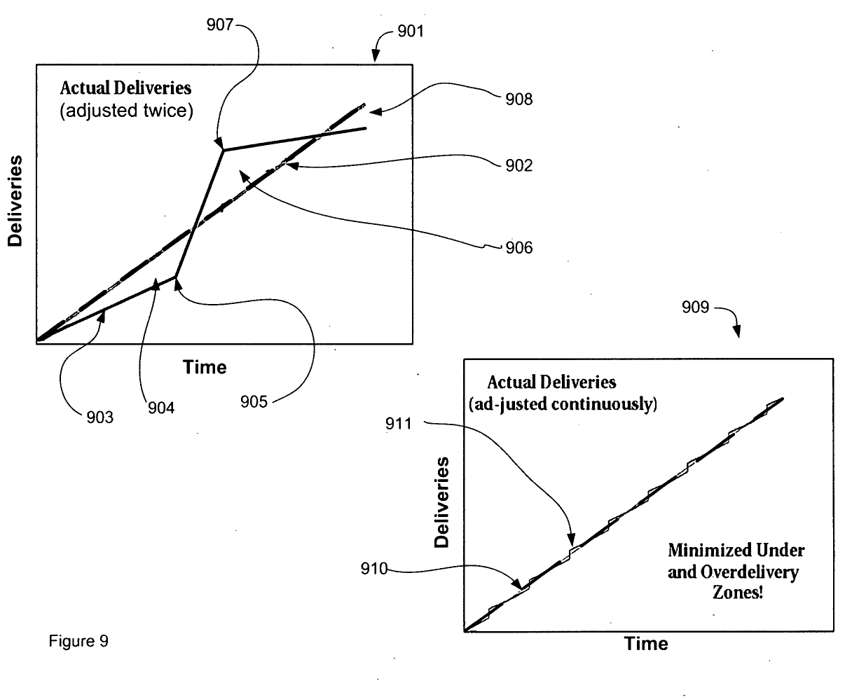

FIG. 9 depicts two graphs for delivery rate scenarios and improvements under the delivery management engine. Prior art adjustments to delivery rate 901, enable just one or two adjustments over the time frame of a campaign interval because of the time burden of collecting the required data. The graph 901 shows the number of deliveries for selected advertisement content versus time. A target rate is a straight line 902 from the start of the campaign interval to the end. However actual deliveries do not necessarily follow this ideal plan. Actual traffic to the site may result in an under delivery 904 of advertisement content against the plan. The management plan of the site can be adjusted 905 to increase the delivery of the selected advertisement content. The slope of delivery is seen to increase at this adjustment point. Non-limiting examples of adjustments include changing the list of content that is to be delivered over the campaign time span, changing the relative priority for each of the individual advertisement content and others as discussed above. The adjustment to the advertisement campaign may result in increased deliveries for the selected content and can result in such an increase that the delivery then exceeds the target line 902. An over-delivery region 906 results. With no further adjustment the count of deliveries of the particular content would exceed the target resulting in loss opportunities to display other content and loss revenue. Time and manpower permitting, a second adjustment 907 could be made which would decrease the delivery rate for the particular content. The changes would mirror those made in the under-delivery situation. Advertisement content that is being delivered at a rate exceeding a target may be lowered in priority for delivery amongst a group of available content through a reduced relative priority scheme or delivery may even be stopped. The result of the adjustment is seen as a reduced slope in the graph of deliveries versus time. If the change is selected ideally the deliveries will end the campaign time span at the targeted value. More likely is another over-correction, which in the example scenario results in an under-delivery 908 and lost revenue. In a preferred embodiment frequent adjustments to the content delivery plan are made. The second graph 909 of FIG. 9 shows a scenario for corrections to delivery rates that occur on a frequent basis. With the additional data available through the present invention the corrections allow the actual deliveries 911 to follow the target plan 910 for specific advertisement content.

In another embodiment a tangible storage medium is encoded to contain software to provide the delivery management engine. The storage medium may be a compact disc medium or a digital video medium or similar such storage means know in the art. The software may then be copied from the tangible storage medium and installed on the servers where the delivery management engine is operated.

### SUMMARY

A delivery management engine that monitors and controls system Internet content delivery, primarily advertisement, is presented. The system uses automated scripts to track delivery of content and includes a discrepancy reconciliation engine that reconciles delivery counts between multiple server systems. The system includes user encoded business rules that enable automatic adjustments to advertisement campaigns to ensure that a contracted number of deliveries is met. The system avoids both over-delivery and under-delivery of content against a target and therefore optimizes the use of valuable advertising space.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. An Internet content delivery management system operating on Internet servers which are running ad server programs said programs delivering content for advertising campaigns for a fixed time interval comprising:
a) a means to encode content delivery rules,
b) a content delivery data acquisition means, and,
c) a data analysis and reconciliation means.

2. The system of claim 1 further comprising a means to adjust a content delivery campaign based upon the encoded delivery rules said delivery campaign including a number of deliveries, a relative priority, and, a daily overage.

3. The system of claim 2 where the content delivery rules comprise at least one of:
a) changing the number of deliveries scheduled,
b) changing the relative priority of a campaign, and
c) changing the daily overage.

4. The system of claim 1 where the data acquisition means comprises matching identifier tags of an advertising content on at least two Internet servers and reports a count of the number of deliveries of the advertising content for each server.

5. The system of claim 4 where the data analysis and reconciliation means calculates a difference between the reported counts for the at least two servers.

6. The system of claim 5 where the delivery rules are adjusted based upon the calculated difference.

7. The system of claim 2 where the encoded delivery rules are applied to ad server programs on at least two Internet servers.

8. The system of claim 3 where the daily overage is increased by an amount inversely proportional to the time remaining for the campaign time interval.

9. A method of managing the delivery of Internet content, said method comprising:
a) a means to encode content delivery rules,
b) a content delivery data acquisition means, and,
c) a data analysis and reconciliation means.

10. The method of claim 9 further comprising a means to adjust a content delivery campaign based upon the encoded delivery rules said delivery campaign including a number of deliveries, a relative priority, and, a daily overage.

11. The method of claim 10 where the content delivery rules comprise at least one of:
a) changing the number of deliveries scheduled,
b) changing the relative priority of a campaign, and
c) changing the daily overage.

12. The method of claim 9 where the data acquisition means comprises matching identifier tags of an advertising content on at least two Internet servers and reports a count of the number of deliveries of the advertising content for each server.

13. The method of claim 12 where the data analysis and reconciliation means calculates a difference between the reported counts for the at least two servers.

14. The method of claim 13 where the delivery rules are adjusted based upon the calculated difference.

15. The method of claim 10 where the encoded delivery rules are applied to ad server programs on at least two Internet servers.

16. The method of claim 11 where the daily overage is increased by an amount inversely proportional to the time remaining for the campaign time interval.

17. A tangible storage medium encoded to contain software to provide an Internet content delivery management system operating on Internet servers which are running ad server programs said programs delivering content for advertising campaigns for a fixed time interval comprising:
a) a means to encode content delivery rules,
b) a content delivery data acquisition means, and,
c) a data analysis and reconciliation means.

18. The tangible storage medium of claim 17 further comprising a means to adjust a content delivery campaign based upon the encoded delivery rules said delivery campaign including a number of deliveries, a relative priority, and, a daily overage.

19. The tangible storage medium of claim 18 where the content delivery rules comprise at least one of:
a) changing the number of deliveries scheduled,
b) changing the relative priority of a campaign, and
c) changing the daily overage.

20. The tangible storage medium of claim 17 where the data acquisition means comprises matching identifier tags of an advertising content on at least two Internet servers and reports a count of the number of deliveries of the advertising content for each server.

21. The tangible storage medium of claim 20 where the data analysis and reconciliation means calculates a difference between the reported counts for the at least two servers.

22. The tangible storage medium of claim 21 where the delivery rules are adjusted based upon the calculated difference.

23. The tangible storage medium of claim 18 where the encoded delivery rules are applied to ad server programs on at least two Internet servers.

24. The tangible storage medium of claim 19 where the daily overage is increased by an amount inversely proportional to the time remaining for the campaign time interval.
